(19) United States
(12) Patent Application Publication
(10) Pub. No.: US 2024/0298581 A1
(43) Pub. Date: Sep. 12, 2024

(54) SEED STARTING TRAY WITH TRANSPARENT CELLS

(71) Applicant: Graham Bowe, Langhorne, PA (US)

(72) Inventor: Graham Bowe, Langhorne, PA (US)

(21) Appl. No.: 18/596,672

(22) Filed: Mar. 6, 2024

Related U.S. Application Data
(60) Provisional application No. 63/450,099, filed on Mar. 6, 2023.

(51) Int. Cl. A01G 9/029

(52) U.S. Cl. CPC A01G 9/0297

(57) ABSTRACT

A receptacle for a seed, seedling, or plant may include an opaque frame within which one or more cells is placed. Each cell has a sidewall that is transparent below the soil surface to enable growers to observe soil moisture level and progression of root growth. The opaque frame prevents light from entering the transparent sidewall of each cell, which would otherwise retard growth of seed, seedling, or plant. An optional tray handle allows growers to lift the cell(s) from the container or watering tray when checking soil moisture level and root growth.

### CROSS-REFERENCE TO RELATED APPLICATIONS

The present application claims priority under 35 USC 119(e) to U.S. Provisional Application No. 63/450,099 filed Mar. 6, 2023, the entire contents of which is incorporated by reference.

### FIELD OF THE EMBODIMENTS

The field of the invention and its embodiments relates to receptacles for growables, which includes seedlings and other plants, and more particularly to a seed starting tray, planting pot, or other growth receptacle having transparent cells within which the growable resides.

### BACKGROUND OF THE EMBODIMENTS

Current seed starting trays are configured to retain soil, water, a seed and/or a seedling. One of the most common mistakes growers make is overwatering or underwatering plants or seedlings. The apparent moisture level at a soil surface can vary significantly with a moisture level at the root ball of the plant/seedling. Additionally, the timing of root growth of seedlings is critical for transplanting purposes and growers often rely on estimations to determine root development of a seedling during the growing process. Estimations are not always efficient and accurate indicators for optimal transplant success of seedlings. Also, it is known for growers to monitor seedling root growth by physically removing the seedling from its growing tray to check for root development. This manual removal process of the seedling during root development checks may damage the fragile and delicate seedling and expose it to contaminants, which may disrupt its homeostasis. As a result, seeding retardation and/or fatal growth development may occur, which may be inefficient for a grower. Thus, there is a need for a grower to visually determine root growth of a seedling without compromising growing conditions and/or having to physically remove the growing seedling from a compartment and/or from a cell of its growing tray. Accordingly, there is a need for a grower to visually check soil moisture level below a soil surface and a further, secondary need, to check root growth below the soil level.

### Review of Related Art

CN115281093A—This reference discloses a system for cultivating tissue culture seedlings into micro bulbs as the production material of the original half-summer seedling, laying the foundation for the factory production of half-summer detoxified seedlings.

CN217936691U—This reference describes an incubator with an electric telescopic rod connected between the upper side of the inner wall of the incubator and the side of the inner wall of the baffle, and a control panel is provided on the side of the outer wall of the incubator. The upper side of the outer wall of the incubator is opened downwards with a vent, one side of the inner wall of the vent is hinged with a matching cover, the cover, the door and the incubator are made of transparent material.

CN115336525A—This reference teaches a cultivation method for hydroponic bonsai of bamboo plants, fixing the absorbent cotton rope in a colonization basket being a glass bottle with a diameter of 20 cm and a height of 20 cm.

CN216164149U—This reference teaches a cotton whole growth period water culture and root system phenotype observation device which comprises a barrel body. The barrel body is a black plastic barrel, a transparent observation window is arranged on the barrel body, a black observation window cover is covered on the transparent observation window, and the black observation window cover is arranged on the barrel body in an opening and closing mode.

CN215223732U—This reference discusses a hydroponic device comprising a culture box and at least one seedling supporting disc. The culture box is a hollow box body with an opening at the top. The seedling supporting disc is in a groove shape provided with a protruding edge and can be clamped to the top of the culture box.

CN215301745U—This reference teaches a root observation apparatus for a sugarcane lodging resistance test, comprising a base plate, the right side of the top of the base plate is fixed connected to the incubator, the material of the incubator is a transparent acrylic material.

### SUMMARY OF THE EMBODIMENTS

In accordance with the principles of the present invention, a seed starting tray, planting pot, or other such receptacle with one or more transparent cell(s) below a soil surface, which enables growers to check soil moisture level and see progression of root growth. A transparency level greater than opaque and sufficient for visual moisture level and root growth detection is contemplated, which may include water-clear to translucent levels of transparency utilizing the standard four-point scale. On the same scale, the receptacle includes an opaque frame within which the cell(s) is positioned. In embodiments a portion of the cell (above the soil surface level) may be opaque, and this opaque portion may extend beyond an upper surface of the opaque frame within which the cell is disposed. Thus, the infrastructure (growth level below the soil surface) of the growable is protected from excessing light from a light source, which can retard or otherwise be harmful to the growable. Visually observing the moisture level and root growth via the transparent portion of the cell requires lifting the cell out of the opaque frame. The disclosed receptacle, which enables below soil viewing via the transparent cell while at the same time does not expose the below soil region to excessive light via the opaque frame is believed to overcome limitations of prior receptable for seedlings and plants.

In one arrangement, a receptable for a growable includes at least one cell and an opaque frame. Each cell has a transparent sidewall portion. The transparent sidewall portion extends from approximately the bottom of the cell to at least above the middle of the cell. The cell is configured to contain soil within which a seed, seedling, or plant grows. The outer periphery of a surface of the contained soil and below is viewable through the transparent sidewall portion. The cells are configured to fit inside an interior of the opaque frame. When the cell(s) are fitted in the frame, emissions from a light sourced needed by the growable strike a top of the surface of the soil but are unable to pass through the transparent sidewall portion. In one embodiment, the bottom of each cell includes drainage slots allowing water to drain such that the interior of the opaque frame functions as a water reservoir for the growable.

In another arrangement, a receptacle for a seed, seedling, or plant includes one or more cells and an opaque frame. Each cell has a sidewall which is transparent below a soil surface. Each cell includes a set of one or more drainage slots for draining water. The opaque frame has one or more interior compartments within which the cells fit. The opaque frame is a water reservoir for the seed, seedling, or plant. When the cell(s) fit inside the interior compartments emissions from a light source strike a soil surface but do not pass through the transparent sidewall of the cells.

In yet another arrangement, a receptacle for a growable includes one or more cells and an opaque frame. The cells include soil, which at least partially contains the growable. The sidewall of each cell below the surface of the soil is transparent. The cell(s) fit within the interior of the opaque frame. The opaque frame blocks emissions from a growing light source, which although these emissions strike the surface of the soil, these emissions are blocked from passing through the transparent sidewall.

### Additional Information

In one embodiment, the receptacle is implemented as a seed starting tray with multiple cells, a planting pot, and the like. The planting pot may include an opaque frame and a single transparent cell, wherein transparent for purposes of the cell as used herein and as assessed on a four-point rank scale includes “water clear”, “transparent”, and “translucent” scaled measurements. The seed starting tray may be molded with a top portion above the soil surface being opaque to prevent sunlight and/or any ambient lighting from penetrating down into the cells. The cells below the soil surface are significantly transparent to allow for a user including, but not limited to, a gardener and/or a grower to check soil moisture below the soil surface and to see growth and/or seedling root balls, at least for portions on the edge of the cells not obscured by the soil. Embodiments use a special two-part molding process and allows growers to track the progress of seedlings.

It is within the scope of this invention for the receptacle for a seedling to have an optional handle configured to allow a user to lift the transparent cell(s) from the opaque frame. This configuration gives a user the ability to below the soil level for moisture level and root growth. The frame is opaque, so light does not penetrate below the soil level to retard root growth of the seedling or plant retained within the transparent cells.

Molded slots in each cell allow for soil drainage and aeration creating optimal conditions to germinate seeds, grow seedlings or grow plants. Channels in the bottom of the frame, which exist in some embodiments, draw excess water away from the cells, while a raised perimeter edge supports an inner cell and keeps water contained in the frame tray. The frame has a molded attachable center handle to make it easy to lift the cell (s) and to pour off excess water or to check on the growable. In one embodiment, rows may be labeled with surface indicia being numerical and/or alphanumerical for growable identification.

### BRIEF DESCRIPTION OF THE DRAWINGS

FIG. 1A is a schematic diagram of an environment within which a receptacle operates according to at least some embodiments disclosed herein:

FIG. 1B is a schematic diagram of a frame of a receptacle according to at least some embodiments disclosed herein;

FIG. 1C is a schematic diagram of a cell of a receptacle according to at least some embodiments disclosed herein;

FIG. 2A depicts a perspective view of the seedling tray caddy with a plurality of transparent cells and a lift handle, according to at least some embodiments disclosed herein;

FIG. 2B depicts a perspective view of the seedling tray caddy with a plurality of transparent cells and a lift handle retained in a watering tray, according to at least some embodiments disclosed herein;

FIG. 2C depicts a perspective view of the seedling tray caddy with a plurality of transparent cells and a lift handle retained in a watering tray, according to at least some embodiments disclosed herein;

FIG. 3 depicts an exploded side view of the seedling tray caddy with a plurality of transparent cells and a lift handle configured to be retained in a watering tray, according to at least some embodiments disclosed herein;

FIG. 4A depicts a potting plant receptacle having a frame and a single cell, according to at least some embodiments disclosed herein;

FIG. 4B depicts the cell of FIG. 4A, according to at least some embodiments disclosed herein;

FIG. 4C depicts the frame of FIG. 4A, according to at least some embodiments disclosed herein;

FIG. 4D depicts a bottom view of the cell of FIG. 4A, according to at least some embodiments disclosed herein; and

FIG. 4E depicts a bottom view of a frame of FIG. 4A, according to at least some embodiments disclosed herein.

### DESCRIPTION OF THE PREFERRED EMBODIMENTS

The preferred embodiments of the present invention will now be described with reference to the drawings. Identical elements in the various figures may be identified with the same reference numerals. Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

As used herein, the singular forms “a,” “an,” and “the,” are intended to include the plural forms as well, unless the context clearly indicates otherwise.

The phrase “and/or,” as used herein in the specification and in the claims, should be understood to mean “either or both” of the elements so conjoined, i.e., elements that are conjunctively present in some cases and disjunctively present in other cases. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one. A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

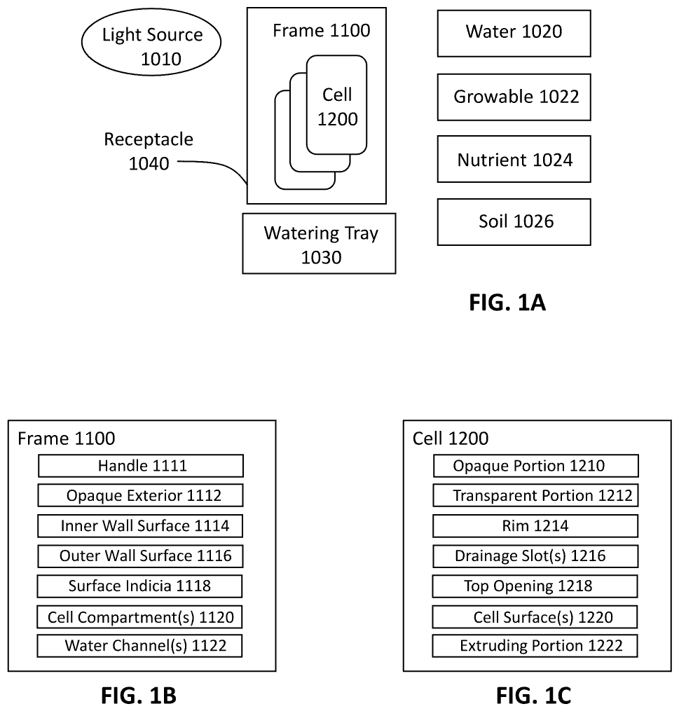

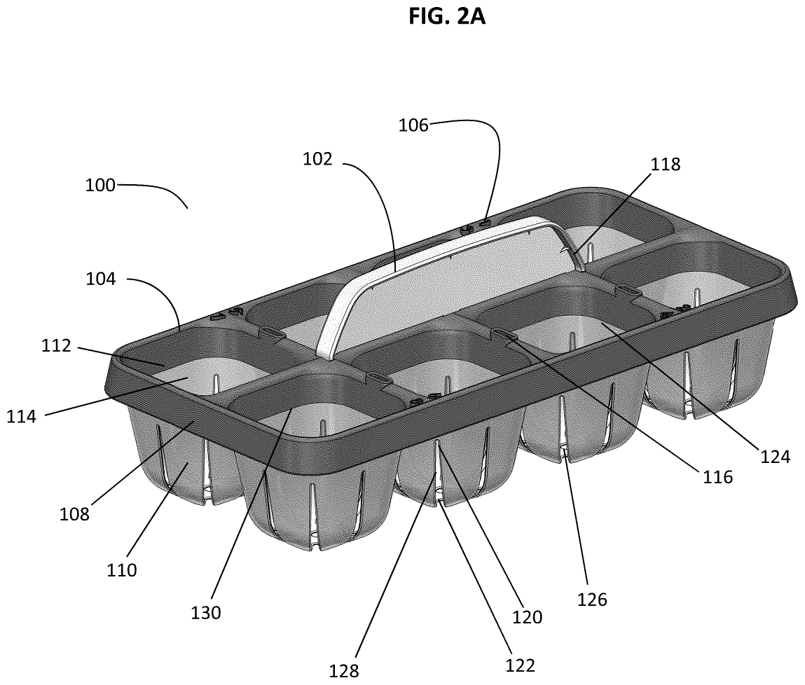

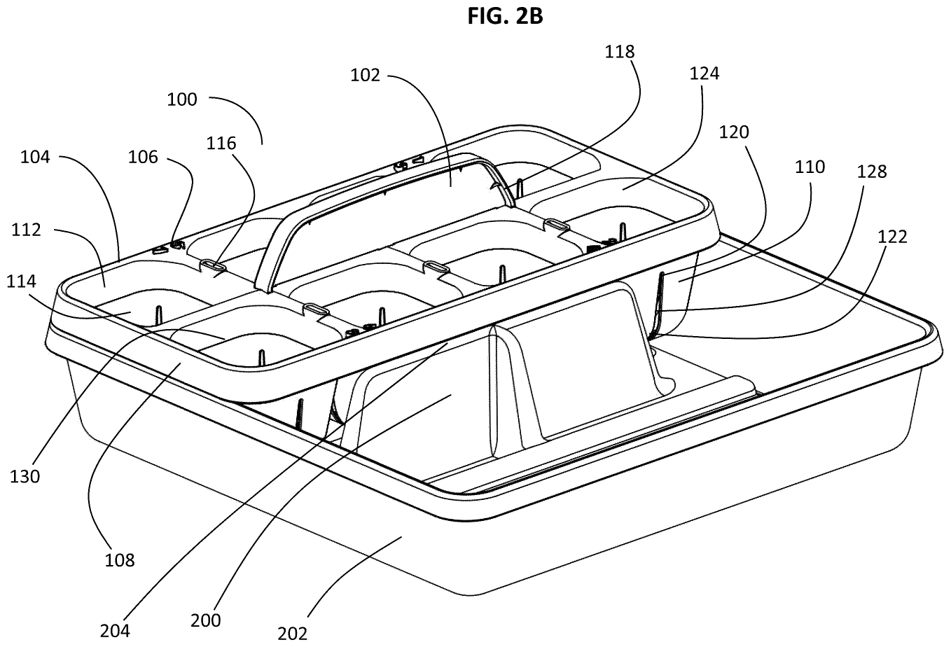

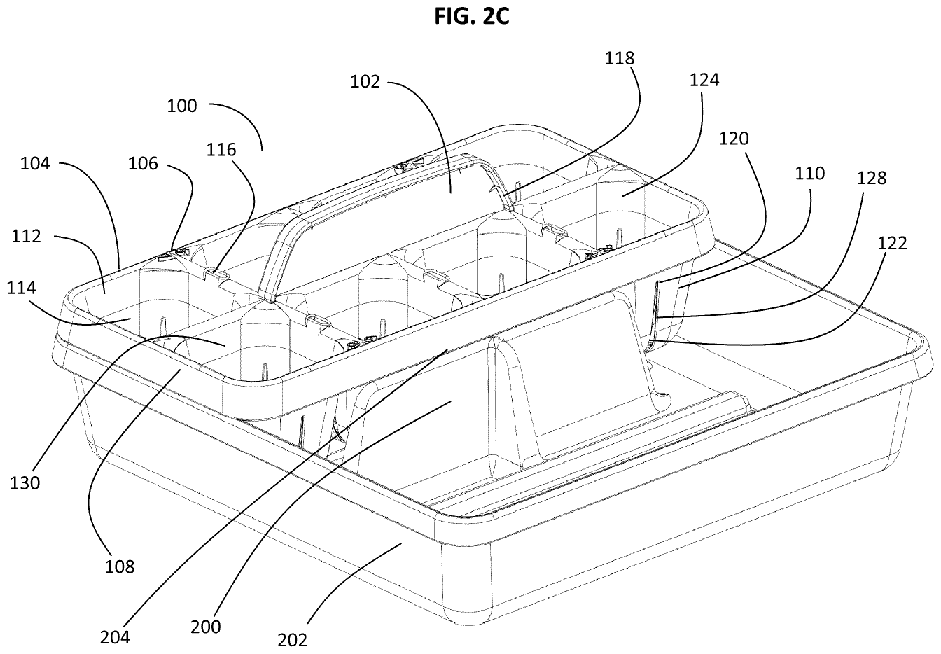

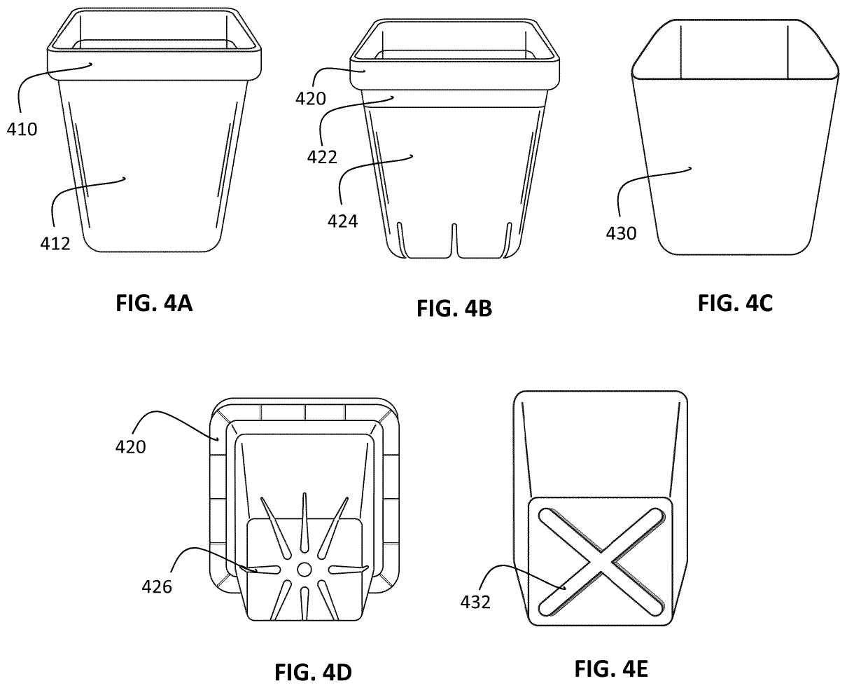

FIG. 1A is a schematic diagram of an environment within which a planting receptacle 1040 operates according to at least some embodiments disclosed herein. In various embodiments, the receptacle 1040 can be a seedling tray with multiple cells 1200, as shown by FIGS. 2A-C and 3, or can be implemented as a pot having a single cell 1200, as shown by FIGS. 4A-4E. With reference to FIGS. 1B and 1C, receptacle 1040 includes at least a frame 1100 and one or more cells 1200, where the frame 1100 is generally opaque and the cells 1200 at least partially transparent. A growable 1022, such as a plant or seeding, is placed in each cell 1200 along with soil 1026, nutrients 1024, and water 1020. Emissions from a light source 1010 needed for growth of the growable 1022 are unable to pass through a sidewall of the opaque frame 1100. The cell(s) 1200, being transparent at least below a soil 1026 surface, can be lifted out of the frame 1100 and can be visually inspected by a grower. The grower looking through the transparent portion of the cell 1200 can observe root growth of the growable 1022 and water 1020 levels below the soil 1026 surface. In one embodiment, a watering tray 1030 can be disposed beneath the frame 1100 to capture water overflow, which is especially significant when water drainage holes are placed in the frame 1100 (and cell(s) 1200). Additional components, such as an automatic watering system, may be included in the environment of FIG. 1A, which does not depart from focus of the disclosure, which is providing a viewing of conditions existing under a soil 1026 surface, while mitigating or preventing damage from direct emissions from source 1010 beneath the soil 1026 surface.

As used herein, a light source 1010 may include the sun or artificially produced light enabling photosynthesis needed for the growable 1022 to thrive. In embodiments, the light source 1010 may be a growing light, such as an LED or fluorescent bulb, which can be specifically selected and changed for the growable 1022. For example, blue light or mixed LED bulbs are often suitable for starting seeds, leafy greens, and non-flowering house plants. Red or mixed light LED bulbs are often suitable for promoting bud formation in flowering plants.

Water 1020 refers to the primary liquid needed by the growable 1022. Water 1020 transports nutrients 1024, helps generate oxygen, and provides necessary thermoregulation to the growable 1022. In various embodiments, the water 1020 can be optimized for the growable 1022, where optimizing can consider water quality, pH level, and whether the water 1020 is hard or soft.

Growable 1022 is a plant or living organism able to be grown within cell 1200. A growable 1022 can be a seed, seedling, or plant. More specifically, growable 1022 is a eukaryote from the kingdom plantae, which is photosynthetic. Growable 1022 suitable for cell 1200 when placed in soil 1026, consumes water 1020 and has a root structure.

Nutrient 1024 is an additive to the soil 1026 that promotes growth. Different types of growables 1022 thrive on different nutrient 1024 concentrations. Common nutrients 1024 include carbon, nitrogen, phosphorus, potassium, calcium, magnesium, sulfur, chloride, iron, boron, manganese, zinc, copper, molybdenum and nickel.

Soil 1026 is a loose surface material that covers most land, which consists of inorganic particles and organic matter. Soil provides the structural support to growables 1022 plants used in agriculture and is also their source of water and nutrients. Different soil 1026 compositions are optimal for different growables 1022.

Receptacle 1040 is a container for plant growth. Although size may vary, receptacle 1040 are generally human carriable, especially as the interior cell 1200 is designed to be periodically lifted from the frame 1100. In embodiment, each cell 1200 may contain a single growable 1022.

Frame 1100 and cell(s) 1200 generally have a topmost opening, a bottom, and a set of sidewalls. A removable topmost transparent cover can be used in embodiments. Frame 110 may include a seeding tray, a pot, and the like. Frames 1110 come in different shapes, where rectangular being common for seeding trays and circular being common for pots. Framed 1100 and cell(s) 1200 can be constructed of various biodegradable or persistent materials, such as fiberglass, plastic, ceramic, terracotta, foam, wood, glass, and the like. Available materials for the cell(s) 1200 is more limited from that of the frame 1100, since the cell 1200 must be at least partially transparent. In embodiments, frame 1100 and cell 1200 can be formed from the same material, where a coating is applied to ensure the frame is opaque instead of transparent.

In embodiments, a relatively tight friction fit can be established between a compartment of the frame 1100 and each cell 1200 to ensure stability. Further, shapes and depths can be matched for close fitting. For example, FIGS. 2A and 4A show two potential configurations designed to enhance stability of cell 1200 when placed within frame 1100. Thus, a grower can move a frame 1100 while the cell 1200 is securely positioned therein and the grower can further remove the cell 1200 from the frame 1100 easily for visual inspection.

Generally transparent, as used herein, refers to allowing light to pass through so that objects behind a sidewall can be seen to a sufficient degree to visually inspect root growth near the sidewall and water 1020 amounts present below the soil 1026 surface. For clarity, it should be assumed that transparency is being defined herein with reference to a human with 20/20 vision not suffering from color blindness. The type and color of light used by the light source 1010 can have an appreciable effect on a grower's ability to see through the sidewall for inspection purposes, as can other material properties. Commonly, transparency is ranked on a four-point scale having categories of water clear, transparent, translucent, and opaque. On this scale, many translucent levels are sufficient for a grower to visually inspect the growable 1022 through a sidewall of cell 1200. Thus, cell 1200 can be scaled as “translucent”, while being considered within the meaning of the term transparent as used herein.

The frame 1100 may have a handle 1111, an opaque exterior 1112, an inner wall surface 1114, an outer wall surface 1116, a surface indicia 1118, one or more cell compartment(s) 1120, and one or more water channel(s) 1122. The cell 1200 may have an opaque portion 1210, a transparent portion 1212, a rim 1214, a drainage slot 1215, a top opening 1218, a cell surface 1220, and an extruding portion 1222. More detail of which is provided in context of specific embodiments presented in FIGS. 2A-4E, which reference receptacle 1040 as element 100; frame 1100 as element 104 or 412; and cell 1200 as element 110 or 410.

FIGS. 2A-2C depict an illustration of receptacle 100 (e.g., one embodiment of receptacle 1040) having attachable handle 102 connected thereto. Handle 102 may have flange 118 protruding from an edge to provide a gripping surface during use. Handle 102 attachment is configured to allow a user including, but not limited to, a gardener, to raise and lower receptacle 100 or seedling tray with one hand. Frame 104 is located on top of transparent cell 110. Frame 104 is opaque to shield roots (not shown) from light (not shown). Frame 104 has an inner wall surface 112 and an outer wall surface 108. Outer wall surface 108 may be flared, sloped, and/or pitched. Outer wall surface 108 over hangs at least a portion of transparent cell 110. Inner wall surface 112 of frame 104 borders compartment 114 of transparent cell 110. Frame 104 may have surface indicia 106. For example, rows of receptable 100 are labeled numerically and/or alphanumerically for seedling identification. Frame 104 has recess 116.

FIGS. 2A-C further show transparent cell 110 having top opening 124 to compartment 114 of transparent cell 110. Top opening 124 of compartment 114 of transparent cell 110 is configured to receive soil (not shown) and a seed (not shown) and/or a root system of a seedling. The transparent cell 110 has top opening 124 located opposite a bottom opening 126 (FIG. 2A). Bottom opening 126 of transparent cell 110 is configured to drain excess water from transparent cell 110. Transparent cell 110 has at least one sidewall having an opening being a slit 128. Slit 128 may be tapered and has first end 120 having a smaller width and/or gap located opposite second end 122 having a larger width and/or gap. The ends of slit 128 may be radiused. Transparent cell 110 may have a plurality of slits. A slit may be located on each corner and/or central portion of transparent cell 110. The slit may extend from a sidewall of transparent cell 110 to the bottom portion of the transparent cell 110. Transparent cell 110 has soil surface 130.

FIGS. 2B and 2C depict receptacle 100 being retained by watering tray 202. Support structure 200 is retained by watering tray 202 and has sidewall 204 that is positioned under outer wall surface 108 of frame 104. Support structure 200, not present in all embodiments, also serves as a divider between portions of watering tray 202.

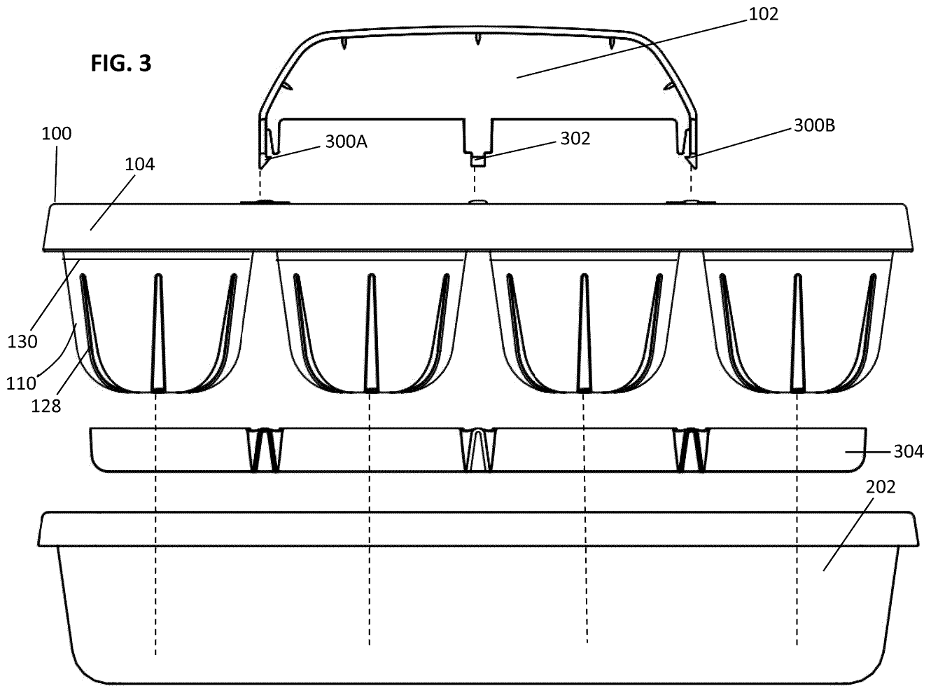

FIG. 3 depicts an illustration of a handle 102 having tabs being clip 300A, 300B, and/or 302 configured to connect to frame 104 of receptable 100. Receptable 100 has at least one transparent cell 110. Transparent cell has slit 128 and soil surface 130. Handle 102 is configured to lift the seed tray and view the root growth. The opaque top frame 104 of the seedling tray and/or receptacle 100 has an optional handle support frame 304 configured to secure handle 102. It is within the scope of this invention for the top frame to be made of any material including, but not limited to, plastic. Watering tray 202 is opaque and is configured to block light from being exposed to roots retained in transparent cell 110.

FIG. 4A depicts a potting plant receptacle, referred to as a two-part flower pot design, having a container 412 (1100) and a single cell 410 (1200), according to at least some embodiments disclosed herein. The cell 410, which serves as an inner pot, is contained within the container 412, where a topmost lip is exposed as an extruding portion 1222 of the cell 410 relative to the container 412. The container 412 serves as a water reservoir and enhanced support structure for the cell 410.

Turning to FIG. 4B, rim 420 provides a surface for seating cell 410 into container 412. Rim 420 is also able to be easily grasped by a grower to raise and lower cell 410 for inspection. As shown, the rim 420 and upper portion 422 of the cell 410 is opaque, where lower portion 424 is transparent. A grower is able to see roots and soil moisture through lower portion 424. FIG. 4D provides an additional perspective view of rim 420. It further shows drainage slots 426, which allow water to drain into the interior of container 412.

FIG. 4C depicts container 412, which may be formed from an opaque plastic or other material. Container 412 blocks light from a light source 1010 and holds water 1020, where cell 410 contains the soil 1026 and the growable 1022. In embodiments, container 412 can have a clean, uniform appearance. In embodiments, different outward appearances 430 for different container 412 can be established for aesthetics. For example, holiday “themed” exteriors can exist to celebrate events; especially since the growable 1022 is contained in a cell 410 designed to be easily removed from and reinserted into container 412. Containers 412 can be stackable for easy storage and reuse. FIG. 4E shows channels 432 in a bottom of the container 412. The channels 432 allow drained water to collect below the cell 410 preventing a bottom of cell 410 from resting in drained water.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the description is intended to cover all of the generic and specific features of the invention herein described, and all statements of the scope of the invention that, as a matter of language, might be said to fall therebetween.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

Now that the invention has been described,

What is claimed is:

1. A receptacle for a growable comprising:
at least one cell having a transparent sidewall portion, said transparent sidewall portion extending from approximately a bottom of the cell to at least above a middle of the cell, wherein the cell is configured to contain soil within which a growable grows, wherein an outer periphery of a surface of the contained soil and below is viewable through the transparent sidewall portion; and
an opaque frame, wherein the at least one cell is configured to fit inside an interior of the opaque frame, wherein emissions from a light sourced needed by the growable strike a top of the surface of the contained soil when the at least one cell is in the interior of the opaque frame, wherein the emissions from the light source do not pass through the opaque frame and do not pass through the transparent sidewall portion when the at least one cell is placed within the interior of the opaque frame.

2. The receptacle of claim 1, wherein a bottom of the at least one cell comprises drainage slots allowing water to drain, and wherein an interior of the opaque container functions as a water reservoir for the growable when the at least one cell is in the interior of the opaque container.

3. The receptacle of claim 2, wherein a bottom of the opaque container comprises a set of channels which allow water to drain away from the at least one cell.

4. The receptacle of claim 1, wherein at least one cell has an opaque sidewall portion.

5. The receptable of claim 4, wherein an extruding portion of a sidewall of the at least one cell extends above a top of the frame when the at least one cell is placed within the interior of the opaque container, wherein the extruding portion is part of the opaque sidewall portion.

6. The receptacle of claim 1, wherein an entirety of the at least one cell is transparent.

7. The receptacle of claim 1, wherein the at least one cell is one cell, wherein the receptacle is two-part pot.

8. The receptacle of claim 1, wherein an upper portion of the at least one cell swells outward so that its exterior dimensions are equal or greater than the exterior dimensions of the container, wherein the upper portion forms a lip able to be grabbed by a human to upwardly lift the cell from the interior of the container.

9. The receptacle of claim 1, wherein the at least one cell comprises at least two cells.

10. The receptacle of claim 1, wherein the at least one cell comprise eight cells arranged to fit inside the frame as two rows of four cells each.

11. The receptacle of claim 9, wherein the receptacle is a seedling tray.

12. The receptacle of claim 1, wherein the growable is one of a seed, a seedling, and plant.

13. The receptacle of claim 9, further comprising a handle for lifting the at least two cells in and out of the interior of the container.

14. The receptacle of claim 1, wherein the handle is detachable.

15. A receptacle for a growable comprising:
one or more cells, each comprising a sidewall which is transparent below a soil surface, each comprising a set of drainage slots for draining water; and
an opaque container having one or more interior compartments within which the one or more cells fit, wherein the opaque container is a water reservoir for the seed, seedling, or plant, wherein when the one or more cells fit inside the interior compartments emissions from a light source strike a soil surface but do not pass through the transparent sidewall of the cells.

16. The receptacle of FIG. 15, wherein the one or more cells is one cell, wherein the one or more interior compartments is one compartment, wherein the receptacle is a two-part pot for the seed, seedling, or plant.

17. The receptacle of claim 16, wherein an upper portion of the cell swells outward so that its exterior dimensions are equal or greater than exterior dimensions of the frame, wherein the upper portion forms a lip able to be grabbed by a human to upwardly lift the cell from the frame.

18. The receptacle of claim 15, wherein the one or more cells is eight cells.

19. A receptacle for a growable comprising:
one or more cells comprising soil, which at least partially contains the growable, wherein a sidewall of each of the one or more cells below a surface of the soil is transparent; and
an opaque frame within which the one or more cells fit, wherein the opaque frame blocks emissions from a growing light source from passing through the transparent sidewall, even though the emissions strike the surface of the soil.

20. The receptacle of claim 19, wherein an upper portion of a sidewall of each of the one or more cells is opaque.
